(19) United States
(12) Patent Application Publication
(10) Pub. No.: US 2010/0164666 A1
(43) Pub. Date: Jul. 1, 2010

(54) Structure and manufacturing process of a coil

(76) Inventors: Shih-Jung Yang, Kaohsiung City (TW); Ming-Te Cheng, Renwu Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,354

(22) Filed: Dec. 29, 2008

(51) Int. Cl. H01F 27/02; B21F 45/00

(52) U.S. Cl. 336/90; 140/71 C

(57) ABSTRACT

A coil includes a coil individual, and a shell part; the coil individual includes a helical coil, which is made by winding a tiny metallic wire, and includes a helical body, and two end wire portions; the coil individual further includes a flexible print circuit, which has electricity-conducting layers on two sides of a middle thereof; the helical coil is positioned on the flexible print circuit, with the two end wire portions thereof and the electricity-conducting layers being joined together to form the frames of the coil individual; the coil individual is wrapped in the shell part with the frames thereof sticking out from the shell part; the frames are bent so as to be closely in touch with an outer side of the shell part.

### BACKGROUND OF THE INVENTION

1. Field of the invention

The present invention relates to a coil, more particularly one, which comprises a coil made of a tiny metallic wire, and a flexible print circuit; the coil is supported and joined on the flexible print circuit, thus being prevented from easily changing shape or becoming loose.

2. Brief Description of the Prior Art

Coils and transformers are common components of various electronic devices and circuit boards. “Novel Coil and the Manufacturing Method Thereof” disclosed in a prior patent application taught a method of manufacturing a coil. According to an embodiment of this method, a cylindrical wire is wound into an electricity-conducting helical coil, and two free end portions of the coil are pressed to become flat. Next, the coil is positioned in a mold together with magnetic powder, and subjected to high pressure, with the two flat free end portions being outside the mold; thus, the coil has a fixed shape, and doesn't have any small crevice for air to travel into, and the two flat free end portions serve as frames of the coil. Next, the frames are bent so as to touch the surface of the coil. The above coil has the following advantages: the frames and the helical body of the coil are made of single wire; the coil has a relatively small volume and low manufacturing cost, and is easy to manufacture. According to another embodiment of this method, a flat wire is wound into an electricity-conducting helical coil instead of a cylindrical one.

“A Manufacturing Method of a Choke Coil” disclosed in a prior patent application includes the following steps:

a winding step: a metallic wire is wound into a helical coil; the metallic wire is divided into upper and lower sections, and the upper and the lower sections are wound in opposite directions so that a coil is formed with free end portions of the upper and the lower sections are outside a helical body of the coil, and the free end portions can be directly connected to frames;

a molding step: the helical coil is positioned in a mold with two free end portions thereof being outside the mold, and next the molding step is carried out to shape the coil; and

a frame-making step: the two free end portions are processed so as to serve as the frames of the coil.

The helical body of the coil will have enough strength to support the frames connected to the two free end portions if the diameter of the metallic wire is large enough. However, coils of modern electronic devices are usually made of tiny metallic wires whose diameter is between 0.016 and 0.02 mm; in this case, the helical body of the coil can't sustain the weight of the frames. Consequently, the coil will become loose and change shape. Therefore, there is still room for improvement.

### SUMMARY OF THE INVENTION

It is a main object of the present invention to provide an improvement on a coil to overcome the above problems.

A coil in accordance with an embodiment of the present invention includes a coil individual, and a shell part. The coil individual includes a helical coil made of a tiny metallic wire, and a flexible print circuit; the flexible print circuit has an electricity-conducting layer on each of two sides thereof; the helical coil is positioned on the flexible print circuit, with two end wire portions of the helical coil and the electricity-conducting layers being joined together to form frames of the coil individual. The coil individual is wrapped in the shell part with the frames thereof sticking out from the shell part; the frames are bent so as to be closely in touch with an outer side of the shell part.

Therefore, the coil individual can't easily change shape or become loose. A process for manufacturing the above-mentioned coil includes winding, coating, cutting, soldering, wrapping and bending steps.

### BRIEF DESCRIPTION OF THE DRAWINGS

The present invention will be better understood by referring to the accompanying drawings, wherein:

FIG. 1 is a flow chart of the manufacturing process in the present invention,

FIG. 2 is a perspective view of a coil of the present invention,

FIG. 3 is a perspective view of a flexible print circuit (FPC) of the present invention, taken after the coating step is carried out,

FIG. 4 is a top view of a flexible print circuit of the present invention, taken after the cutting step is carried out,

FIG. 5 illustrates the soldering step, wherein the tail ends of the coils and the electricity-conducting layer are soldered together,

FIG. 6 is a perspective view of a coil individual of the invention,

FIG. 7 is a sectional view of the coil individual in FIG. 6,

FIG. 8 illustrates the wrapping step,

FIG. 9 is a perspective view of the present invention, taken after the electrode parts of the coil individual are bent,

FIG. 10 is a flow chart of a second manufacturing process in the present invention, and

FIG. 11 is a view of the coils and the FPC, taken when the soldering step of the second manufacturing process is being carried out.

### DETAILED DESCRIPTION OF THE PREFERRED EMBODIMENTS

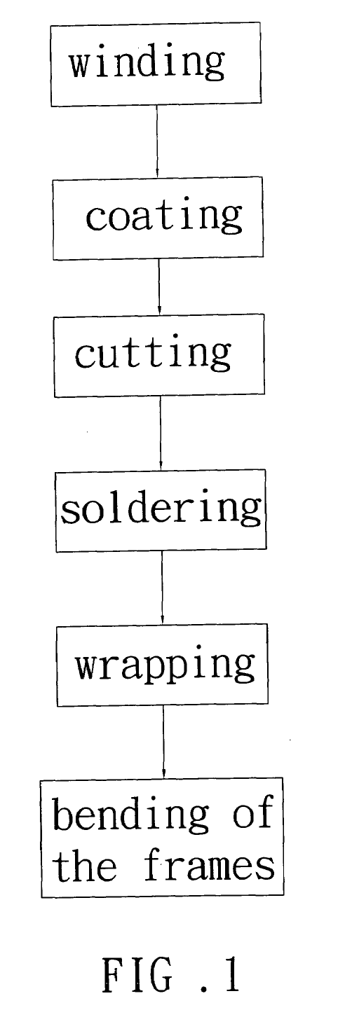

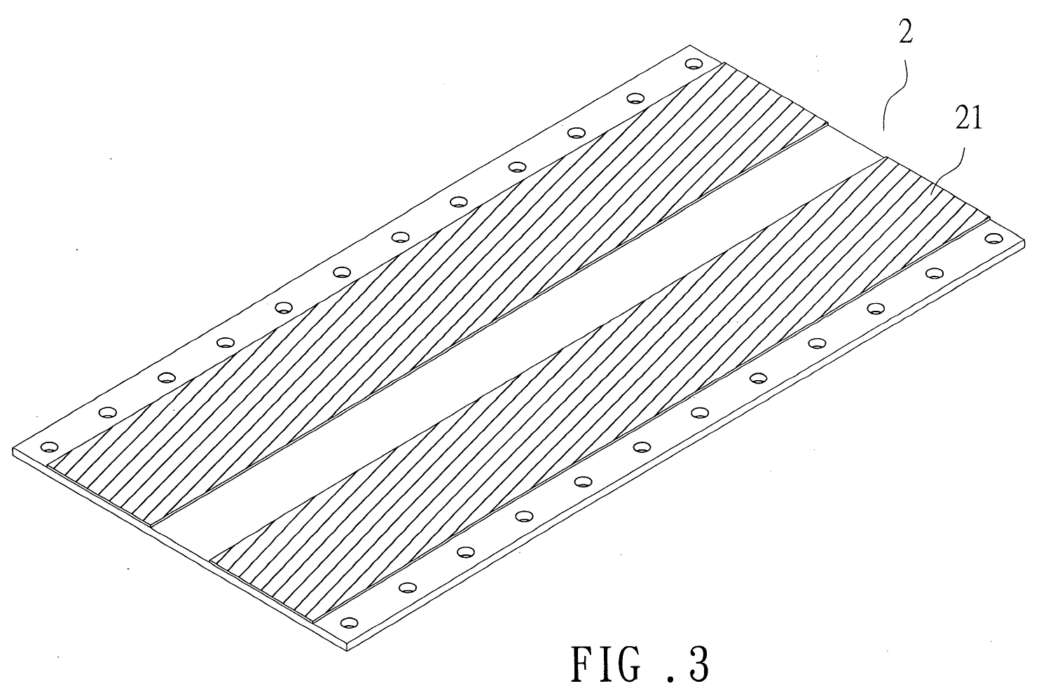

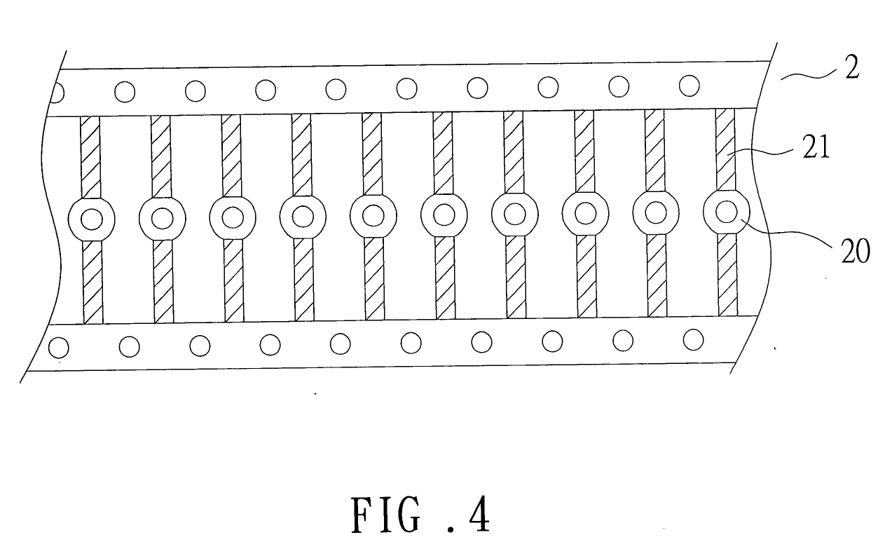

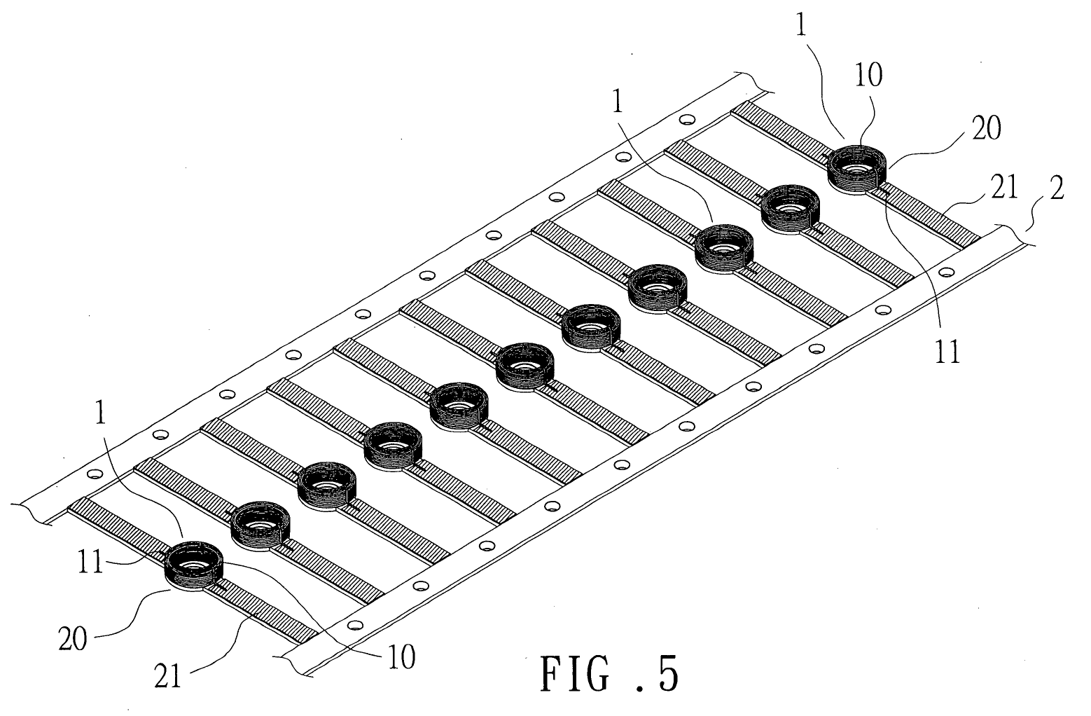

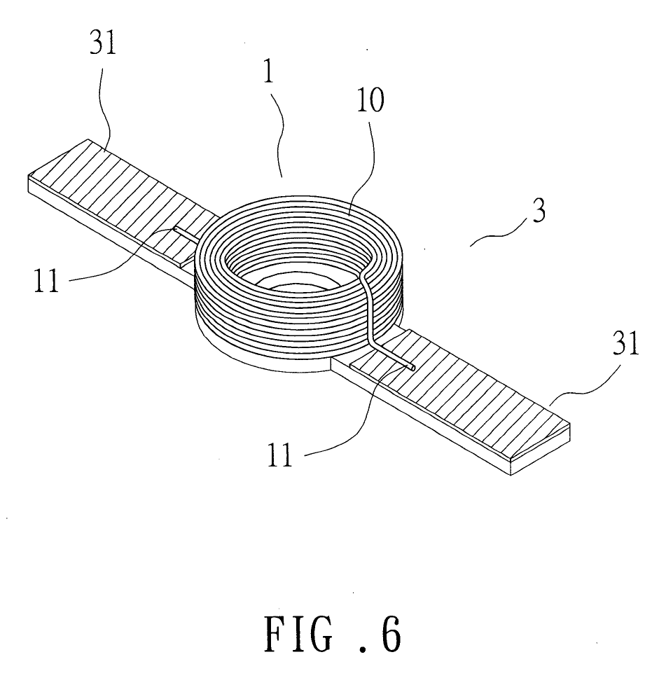

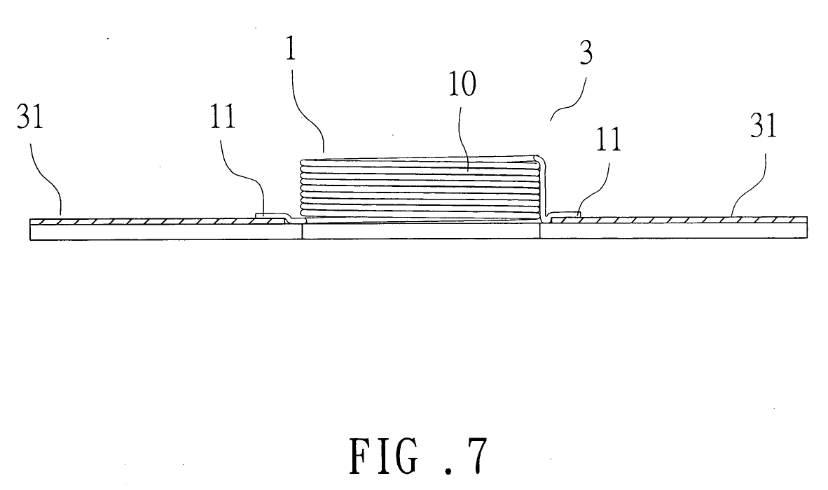

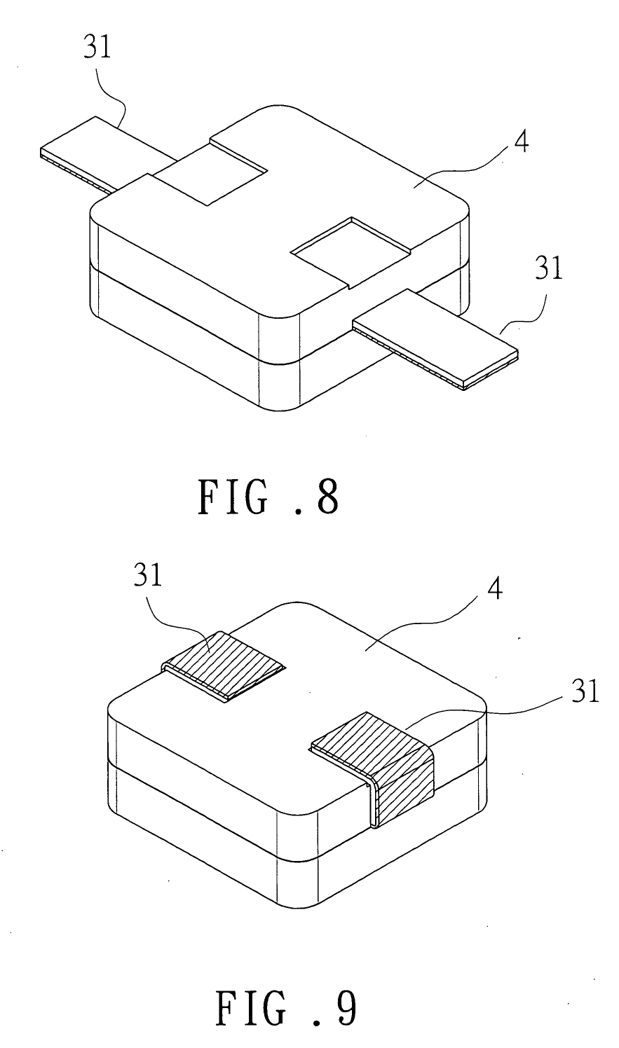

Referring to FIG. 1 to FIG. 9, in a first preferred embodiment of the present invention, a manufacturing process of a coil includes the following steps:

(a) a winding step: tiny metallic wires 10 are wound into helical coils 1 by means of a coil winding machine; the helical coils 1 each have two end wire portions 11;

(b) a coating step: a flexible print circuit (FPC) 2 is prepared, which is formed with electricity-conducting layers 21 on two sides of a middle portion thereof by means of a coating method;

(c) a cutting step: the flexible print circuit 2 is cut so as to have plural continuous flexible print circuits 2, which each have a middle supporting portion 20, and electricity-conducting layers 21 on two sides of the middle supporting portion 20 as to match one said coil 1;

(d) a soldering step: the coils 1 are positioned on said plural flexible print circuits 2 respectively, with the middle helical parts of the coils 1 being propped on the middle supporting portions 20, and with the end wire portions 11 of each of the coils 1 being propped on corresponding said electricity-conducting layers 21; next, the end wire portions 11 of the coils 1 and the electricity-conducting layers 21 of said plural flexible print circuits 2 are soldered together so as to form plural coil individuals 3, which each have two frames 31; next, a cutting step is carried out to separate the coil individuals 3 from each other;

(e) a wrapping step: the coil individuals 3 are each wrapped in a shell part 4, with their frames 31 sticking out from the shell parts 4; and

(f) a bending step for the frames: we bend those portions of the frames 31 of the coil individuals 3 that are outside the shell parts 4; thus, we have the finished products.

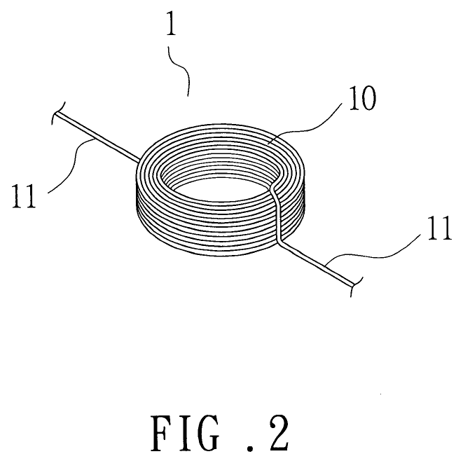

Referring to FIG. 2 to FIG. 9 again, the finished coil product made according to the manufacturing process of the present invention includes:

a coil individual 3; the coil individual 3 includes a coil 1 made of a tiny metallic wire 10, and a flexible print circuit 2, which has electricity-conducting layers 21 on two sides of a middle portion thereof; the coil 1 is propped on the flexible print circuit 2, with two end wire portions 11 of the coil 1 and the electricity-conducting layers 21 of the flexible print circuit 2 being joined together to become the frames 31 of the coil individual 3; and

a shell part 4, in which the coil individual 3 is wrapped; the frames 31 of the coil individual 31 stick out from the shell part 4, and are bent so as to be closely in touch with an outer side of the shell part 4.

Therefore, the coil individual 3 is protected so as not to change shape by means of the shell part 4.

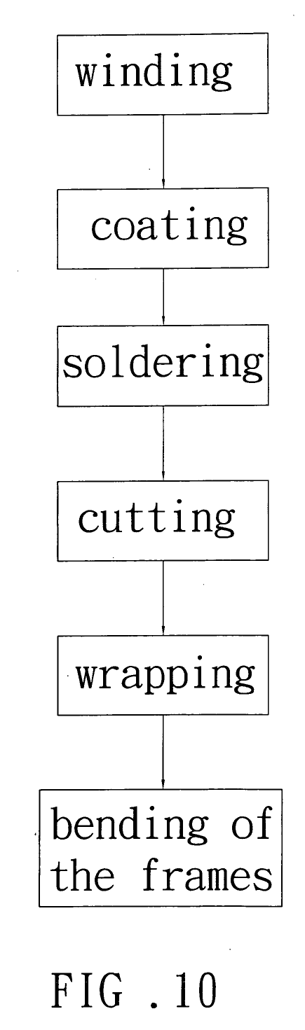

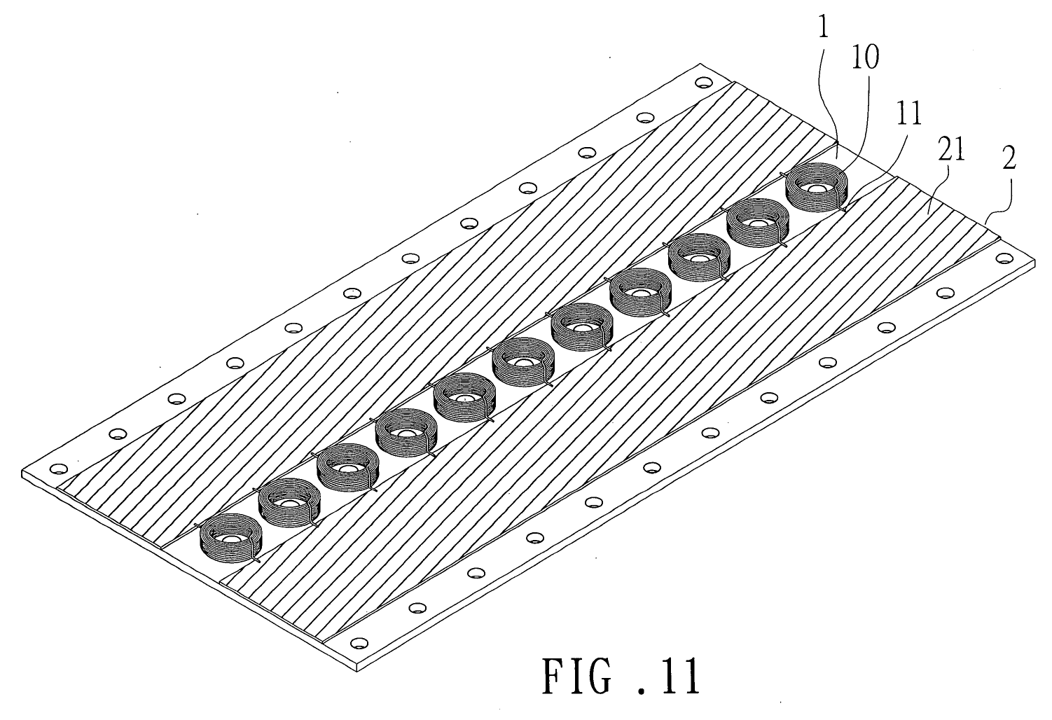

Referring to FIG. 10 and FIG. 11, in a second preferred embodiment of the present invention, a manufacturing process of a coil includes the following steps:

(a) a winding step: tiny metallic wires 10 are wound into helical coils 1 by means of a coil winding machine; the helical coils 1 each have two end wire portions 11;

(b) a coating step: a flexible print circuit (FPC) 2 is prepared, which is formed with electricity-conducting layers 21 on two sides of a middle portion thereof by means of a coating method;

(c) a soldering step: plural said helical coils 1 are positioned on the flexible print circuit 2, with the end wire portions 11 of each of the coils 1 being joined on the electricity-conducting layers 21 respectively by means of soldering;

(d) a cutting step: the flexible print circuit 2 is cut into plural flexible print circuits, which match the coils 1, and each have one of the coils 1 thereon; said plural flexible print circuits each have a middle supporting portion 20, and two electricity-conducting layers 21 on two sides of the middle supporting portion 20; the middle helical parts of the coils 1 are supported on the middle supporting portions 20 respectively; each said flexible print circuit and its corresponding coil 1 comprise a coil individual 3 having two frames 31;

(e) a wrapping step: the coil individuals 3 are each wrapped in a shell part 4, with their frames 31 sticking out from the shell parts 4; and

(f) a bending step for the frames: we bend those portions of the frames 31 of the coil individuals 3 that are outside the shell parts 4; thus, we have the finished products.

In the wrapping step, the shell part 4 can include upper and lower parts, which are formed in a mold assembly including two mold parts, so that the upper and the lower parts of the shell parts 4 are directly joined together to cover one coil individual 3 in the molding process. Or alternatively, the shell part 4 can be made of metallic powder, and formed around one said coil individual 3 by means of molding method; the coil individual 3 and metallic powder are positioned in a mold, and subjected to high pressure and heat so that the metallic powder solidifies to become the shell part 4.

From the above description, it can be seen that the present invention has the following advantages over the prior arts:

1. The coil of the present invention is supported on the flexible print circuit (FPC). Therefore, the coil can't change shape even if it is made of tiny metallic wire.

2. The flexible print circuit can prevent the coil from becoming loose in the manufacturing process. Therefore, the manufacturing process will be relatively smooth.

3. Because coils are positioned on the flexible print circuit in manufacturing, several coil individuals can be made at the same time. Therefore, the present method for manufacturing coils is relatively efficient.

What is claimed is:

1. A coil structure, comprising
a coil individual; the coil individual including a coil made of a tiny metallic wire, and a flexible print circuit; the flexible print circuit having electricity-conducting layers on two sides of a middle portion thereof; the coil being positioned on the flexible print circuit, with two end wire portions of the coil and the electricity-conducting layers being joined together to form frames of the coil individual; and
a shell part; the coil individual being wrapped in the shell part with the frames sticking out from the shell part; the frames being bent so as to be closely in touch with an outer side of the shell part.

2. The coil structure as claimed in claim 1, wherein the shell part includes upper and lower parts, which are formed in a mold assembly-so as to be joined together to cover the coil individual.

3. The coil structure as claimed in claim 1, wherein the shell part is made of metallic powder, and formed around the coil individual by means of a molding method; the coil individual and metallic powder being positioned in a mold, and subjected to high pressure and heat so that the metallic powder solidifies.

4. A manufacturing process of a coil, comprising following steps:
(a) a winding step: tiny metallic wires are wound into helical coils by means of a coil winding machine; the helical coils each have two end wire portions;
(b) a coating step: a flexible print circuit (FPC) is prepared, which is formed with electricity-conducting layers on two sides of a middle thereof by means of a coating method;
(c) a cutting step: the flexible print circuit is cut so as to have plural continuous flexible print circuits, which each have a middle supporting portion, and electricity-conducting layers on two sides of the middle supporting portion as to match one said helical coil;
(d) a soldering step: the helical coils are joined on said plural flexible print circuits respectively to form plural coil individuals, with middle helical parts of the helical coils being propped on the middle supporting portions, and with the end wire portions of each of the coils being propped on corresponding said electricity-conducting layers; next, the end wire portions of the helical coils and the electricity-conducting layers of said plural flexible print circuits are soldered together so as to form frames of said plural coil individuals; next, a cutting step is carried out to separate the coil individuals from each other;
(e) a wrapping step: the coil individuals are each wrapped in a shell part, with the frames thereof sticking out from the shell parts; and
(f) a bending step for the frames: we bend those portions of the frames of the coil individuals that are outside the shell parts.

5. The manufacturing process of a coil as claimed in claim 4, wherein the shell part includes upper and lower parts, which are formed in a mold assembly so as to be joined together to cover the coil individual.

6. The manufacturing process of a coil as claimed in claim 4, wherein the shell part is made of metallic powder, and formed around the coil individual by means of a molding method; the coil individual and metallic powder being positioned in a mold, and subjected to high pressure and heat so that the metallic powder solidifies.

7. A manufacturing process of a coil, comprising following steps:
(a) a winding step: tiny metallic wires are wound into helical coils by means of a coil winding machine; the helical coils each have two end wire portions;
(b) a coating step: a flexible print circuit (FPC) 2 is prepared, which is formed with electricity-conducting layers on two sides of a middle thereof by means of a coating method;
(c) a soldering step: plural said helical coils are positioned on the flexible print circuit, with the end wire portions of each of the helical coils being joined on the electricity-conducting layers respectively by means of soldering;
(d) a cutting step: the flexible print circuit is cut into plural second flexible print circuits, which match the helical coils, and each have one of the helical coils thereon; said plural second flexible print circuits each having a middle supporting portion, and electricity-conducting layers on two sides of the middle supporting portion; middle helical parts of the helical coils being supported on the middle supporting portions respectively; each said second flexible print circuit and its corresponding coil comprising a coil individual having two frames;
(e) a wrapping step: the coil individuals are each wrapped in a shell part, with the frames thereof sticking out from the shell parts; and
(f) a bending step for the frames: we bend those portions of the frames of the coil individuals that are outside the shell parts.

8. The manufacturing process of a coil as claimed in claim 7, wherein the shell part includes upper and lower parts, which are joined together to cover the coil individual.

9. The manufacturing process of a coil as claimed in claim 7, wherein the shell part is made of metallic powder, and formed around the coil individual by means of a molding method; the coil individual and metallic powder being positioned in a mold, and subjected to high pressure and heat so that the metallic powder solidifies.
